(19) United States
(12) Patent Application Publication
(10) Pub. No.: US 2013/0150075 A1
(43) Pub. Date: Jun. 13, 2013

(54) Method and Device for Automatic Vehicle Location Monitoring and Related Communication System

(71) Applicant: Yu-Wei Fan, New Taipei City (TW)

(72) Inventor: Yu-Wei Fan, New Taipei City (TW)

(21) Appl. No.: 13/403,958

(22) Filed: Feb. 23, 2012

(30) Foreign Application Priority Data
Dec. 9, 2011 (TW) 100145527

(51) Int. Cl. H04W 4/04

(52) U.S. Cl. 455/456.1

(57) ABSTRACT

A method of automatic vehicle location (AVL) monitoring for a communication system includes a mobile communication module camping on a cell of the communication system when receiving system information broadcasted by the cell, and the mobile communication module transmitting a message including location information to a location server in the communication system via the cell.

### BACKGROUND OF THE INVENTION

1. Field of the Invention

The present invents relates to a method and device for automatic vehicle location (AVL) monitoring and related communication system, and more particularly, to a method and device for automatic vehicle location monitoring and related communication system without a subscriber identity module (SIM) card.

2. Description of the Prior Art

The Global Positioning System (GPS), which provides accurate positioning, speed detection, and high-resolution time, was restricted to use in military units of the United States until 1984, and the selective availability (SA) added to public use was further canceled in 2000, improving positioning accuracy, and driving heavy development in related markets.

Location services (LCS) provided by the Global Positioning System (GPS) have been widely deployed in in-car navigation devices and mobile devices, and the 3^{rd} Generation Partnership Project (3GPP) develops a standard for location services in mobile devices. In the location services, three location technologies are mainly defined, which are cell identity (Cell-ID), Observed Time Difference of Arrival (OTDOA), and Assisted Global Positioning System (A-GPS). Among the three location technologies, the A-GPS utilizes the original GPS technology with assisted location information for facilitating both location speed and location accuracy.

Location services have been widely applied to location-based services with growth in hardware/software for mobile communication. The location-based services provide vehicle navigation, emergency rescue, local information, local advertisements and social communities according to a user's location, becoming increasingly important in making life more convenient. However, known location-based services are provided only for a mobile device that contains a valid SIM card. That is, a mobile device without a valid SIM card can not transmit location information, and eventually the mobile device can not receive location-based services, or can only access offline location-based services. An automatic vehicle location monitoring device without a valid SIM card can only use offline vehicle navigation functions without updating location information to the communication system, such that a third party (e.g. a car rental or insurance company) can not obtain the location information of the automatic vehicle location monitoring device via accessing the location server.

### SUMMARY OF THE INVENTION

It is therefore a primary objective of the present to provide a method and device of automatic vehicle location (AVL) monitoring and related communication system.

An embodiment of the invention discloses a method of AVL monitoring for a communication system, which comprises a mobile communication module camping on a cell of the communication system when receiving system information broadcasted by the cell; and the mobile communication module transmitting a message including location information to a location server in the communication system via the cell.

An embodiment of the invention further discloses a communication system, which comprises a mobile communication module ; a Global Positioning System (GPS) module for receiving signals from a plurality of satellites and obtaining location information accordingly; a processing unit for executing a program code; and a data storage unit for storing the location information and the program code, the program code directing the processing unit to execute the following procedures: camping on a cell of the communication system when receiving system information broadcasted by the cell; and transmitting a message including location information to a location server in the communication system via the cell.

An embodiment of the invention further discloses a communication system, which comprises an AVL monitoring device comprising a mobile communication module; a GPS module for receiving signals from a plurality of satellites and obtaining a location information accordingly; a processing unit for executing a program code; and a data storage unit for storing the location information and the program code; a radio access technology (RAT) system; and a location server for recoding the location information of the AVL monitoring device; wherein the program code directs the processing unit to execute the following procedures: camping on a cell of the communication system when receiving system information broadcasted by the cell ; and transmitting a message including location information to a location server in the communication system via the cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an embodiment of the invention.

FIG. 2 is a schematic diagram of the automatic vehicle location monitoring device in FIG. 1.

FIG. 3 is a flowchart diagram of an automatic vehicle location monitoring process according to an embodiment of the invention.

### DETAILED DESCRIPTION

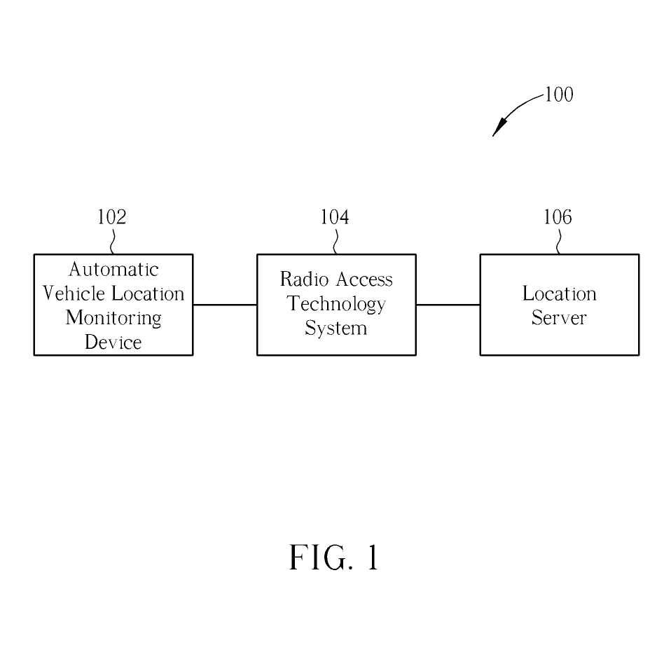

Please refer to FIG. 1, which is a schematic diagram of a communication system 100 according to an embodiment of the invention. The communication system 100 includes an automatic vehicle location (AVL) monitoring device 102, a radio access technology system 104 and a location server 106. The radio access technology can be, but is not limited to, Global System for Mobile Communications (GSM) or Universal Mobile Telecommunications System (UMTS) . The AVL monitoring device 102 sends location information to the location server 106 through the radio access technology system 104, such that a third party can obtain the location information of the automatic vehicle location monitoring device 102 by accessing the location server 106. As such, the automatic vehicle location monitoring device 102 can be without a subscriber identity module (SIM) card or disable a SIM card.

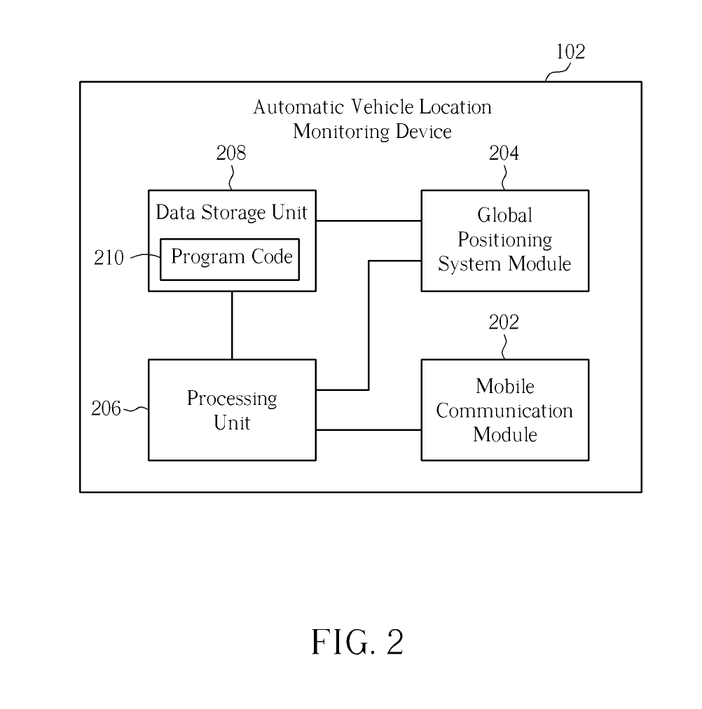

In detail, please also refer to FIG. 2, which is a schematic diagram of the AVL monitoring device 102 in FIG. 1. The AVL monitoring device 102 includes a mobile communication module 202, a Global Positioning System (GPS) module 204, a processing unit 206 and a data storage unit 208. The mobile communication module 202 receives signals from the radio access technology system 104, and transmits signals to the radio access technology system 104. The GPS module 204 receives satellite signals and obtains location information (e.g. longitude, latitude and altitude) of the AVL monitoring device 102 according to information of the satellite signals. The processing unit 206 controls the mobile communication module 202 and the GPS module 204. The data storage unit 208 stores the location information of the AVL monitoring device 102 and a program code 210. The program code 210 directs the processing unit 206 to perform AVL monitoring steps, including controlling the mobile communication module 202 to camp on a cell that supports a function of location information transmitting, then transmitting the message containing location information to the location server 106.

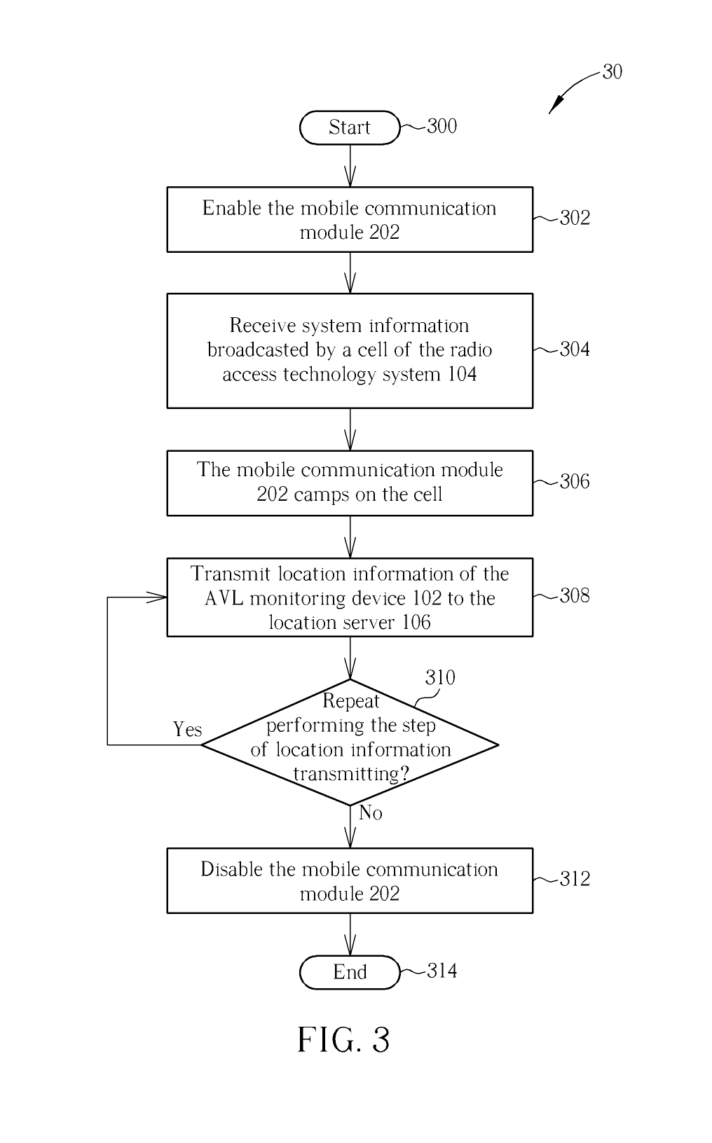

Please refer to FIG. 3, which is a flowchart diagram of an AVL monitoring process 30 according to an embodiment of the invention. The AVL monitoring process 30 is an operating process of the communication system 100, which is performed when the AVL monitoring device 102 is going to transmit location information to the location server 106. The AVL monitoring process 30 can be compiled to the program code 210, including the following steps:

Step 300: Start.

Step 302: Enable the mobile communication module 202.

Step 304: Receive system information broadcasted by a cell of the radio access technology system 104.

Step 306: The mobile communication module 202 camps on the cell .

Step 308: Transmit location information of the AVL monitoring device 102 to the location server 106.

Step 310: Check whether to perform the step of location information transmitting. If yes, go to Step 308; otherwise, go to Step 312.

Step 312: Disable the mobile communication module 202.

Step 314: End.

According to the AVL monitoring process 30, when the AVL monitoring device 102 needs to transmit location information to the location server 106, the processing unit 206 enables the mobile communication module 202. The mobile communication module 202 determines whether a cell supports the function of location information transmitting when receiving system information broadcasted by the cell. If the cell supports the function of location information transmitting, the mobile communication device 202 camps on the cell and then transmits the location information to the location server 106. Note that the processing unit 206 waits for location information provided by the GPS module 204 if the location information is not yet available; once the location information is available, the mobile communication device 202 starts transmitting the location information to the location server 106. The cell is an acceptable cell corresponding to the mobile communication module 202 because the mobile communication module 202 must camp on an acceptable cell to access limited services. In the present invention, the function of location information transmitting is a kind of limited service. After the location information transmitting step, the processing unit 206 may repeat the location information transmitting step for transmitting updated location information to the location server 106, or stop performing the location information transmitting step by disabling the mobile communication module 202. Whether to repeat performing the location information transmitting step and how often to perform the location information transmitting step or other related configurations are in the scope of the present invention.

In the known art, the AVL monitoring device must use a SIM card to transmit location information. In comparison, in the present invention, the location vehicle location monitoring device may camp on a cell supporting the function of location information transmitting without a SIM card to transmit the location information to the location server, and allow a third party to obtain the location information of the AVL monitoring device by accessing the location server. Therefore, in comparison with the known art, the present invention simplifies the location information transmitting step, and saves deployment of the SIM card, cost, and related power consumption.

In conclusion, the AVL monitoring device in the present invention transmits location information to a location server without a SIM card, which can simplify the location information transmitting step, and save deployment of the SIM card, cost, and related power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatic vehicle location (AVL) monitoring for a communication system, comprising:
a mobile communication module camping on a cell of the communication system when receiving system information broadcasted by the cell; and
the mobile communication module transmitting a message including location information to a location server in the communication system via the cell.

2. The method of claim 1, wherein the mobile communication module does not comprise a subscriber identity module (SIM) card.

3. The method of claim 1, wherein the mobile communication module disables a subscriber identity module (SIM) card.

4. The method of claim 1, wherein the system information indicates that the cell supports a function for location information transmitting, and the function for location information transmitting indicates that the mobile communication module can send the location information to the location server via the cell.

5. The method of claim 4, wherein the cell is an acceptable cell corresponding to the mobile communication module.

6. The method of claim 1, wherein the location information is obtained by a Global Positioning System (GPS) module.

7. The method of claim 1, wherein the transmitting procedure can be repeated.

8. An automatic vehicle location (AVL) monitoring device for a communication system, comprising:
a mobile communication module;
a Global Positioning System (GPS) module, for receiving signals from a plurality of satellites, and obtaining location information accordingly;
a processing unit, for executing a program code; and
a data storage unit, for storing the location information and the program code, the program code directing the processing unit to execute the following procedures:
camping on a cell of the communication system when receiving system information broadcasted by the cell; and
transmitting a message including location information to a location server in the communication system via the cell.

9. The AVL monitoring device of claim 8, wherein the mobile communication module does not comprise a subscriber identity module (SIM) card.

10. The AVL monitoring device of claim 8, wherein the mobile communication module disables a subscriber identity module (SIM) card.

11. The AVL monitoring device of claim 8, wherein the system information indicates that the cell supports a function for location information transmitting, and the function for location information transmitting indicates that the mobile communication module can send the location information to the location server via the cell.

12. The AVL monitoring device of claim 11, wherein the cell is an acceptable cell corresponding to the mobile communication module.

13. The AVL monitoring device of claim 8, wherein the transmitting procedure can be repeated.

14. A communication system, comprising:
an automatic vehicle location (AVL) monitoring device, comprising:
a mobile communication module;
a Global Positioning System (GPS) module, for receiving signals from a plurality of satellites, and obtaining a location information accordingly;
a processing unit, for executing a program code; and
a data storage unit, for storing the location information and the program code;
a radio access technology (RAT) system; and
a location server, for recoding the location information of the AVL monitoring device;
wherein the program code directs the processing unit to execute the following procedures:
camping on a cell of the communication system when receiving system information broadcasted by the cell; and
transmitting a message including location information to a location server in the communication system via the cell.

15. The communication system of claim 14, wherein the mobile communication module does not comprise a subscriber identity module (SIM) card.

16. The communication system of claim 14, wherein the mobile communication module disables a subscriber identity module (SIM) card.

17. The communication system of claim 14, wherein the RAT system is a Global System for Mobile Communications (GSM) or a Universal Mobile Telecommunications System (UMTS).

18. The communication system of claim 17, wherein each of the plurality of cells of the RAT system supports a function for location information transmitting, and the function for location information transmitting indicates that the mobile communication module can send the location information to the location server via a cell of the plurality of cells.

19. The communication system of claim 18, wherein the cell of the plurality of cells is an acceptable cell corresponding to the mobile communication module.

20. The communication system of claim 14, wherein the transmitting procedure can be repeated.
